(19) United States
(12) Patent Application Publication
(10) Pub. No.: US 2019/0097743 A1
(43) Pub. Date: Mar. 28, 2019

(54) RADIO BROADCAST RECEIVING METHOD, DEVICE, AND VEHICLE-MOUNTED SYSTEM

(71) Applicants: Zhejiang Geely Holding Group Co., Ltd., Hangzhou City, Zhejiang Province (CN); Zhejiang Geely Automobile Research Institute Co., Ltd., Linhai City, Zhejiang Province (CN)

(72) Inventor: SHUFU LI, Hangzhou City, Zhejiang Province (CN)

(21) Appl. No.: 16/081,915

(22) PCT Filed: Jul. 22, 2016
(86) PCT No.: PCT/CN2016/091020

§ 371 Date: Sep. 2, 2018

(30) Foreign Application Priority Data
Mar. 2, 2016 (CN) 201610118813.X

(51) Int. Cl. H04H 60/27; H04H 20/57; H04H 40/27; H04H 20/42

(52) U.S. Cl. CPC H04H 60/27; H04H 20/57; H04H 2201/30; H04H 20/423; H04H 40/27

(57) ABSTRACT

The radio broadcast receiving method, device and the vehicle-mounted system are provided. The radio broadcast receiving method includes: receiving and storing radio signals; playing the stored radio signals; receiving a pause request, stopping playing the stored radio signals, recording a pause point, continuing receiving and storing the radio signals; and receiving a radio playing signal, playing the stored radio signals from the pause point.

### CROSS REFERENCE TO RELATED APPLICATION

The present application is based on and claims priority of Chinese Patent Application No. 201610118813.X, filed on Mar. 2, 2016. The entire disclosure of the above-identified application, including the specification, drawings and claims are incorporated herein by reference in its entirety.

### FIELD OF THE INVENTION

The present disclosure relates to radio broadcast technology, and more particularly to a radio broadcast receiving method, a radio broadcast receiving device, and a vehicle-mounted system.

### BACKGROUND OF THE INVENTION

Nowadays, more and more people prefer driving to and from work regularly. Because the driver must keep his hands on the steering wheel and keep his eyes on road conditions while driving, he cannot take his hands off of the steering wheel to use a communication device, such as a telephone device, and also cannot drive and watch a vehicle screen at the same time. Moreover, enabling the driver to keep his hands on the steering wheel and put his focus on the road while driving is an important safety requirement. Generally a radio system is installed on the vehicle. Through a speaker, this radio system is used to audibly broadcast radio programs about road traffic information, etc. to the driver in a limited area. For many drivers, they choose to listen to the radio, thus radio programs are getting good ratings in vehicles.

In addition, other electronic devices, such as vehicle telephone devices or navigation devices, are also integrated in or otherwise cooperate with the vehicle. Sometimes these electronic devices are used to broadcast information to the drivers through a same sound output module, i.e., the vehicle's speaker, as the radio system or other audio sources in the vehicle. When the sound output module is occupied by other electronic devices to output the sound of the above-mentioned information, the output of sound signals from the radio or other audio sources is paused until transmission from the other electronic devices is completed. If the audio source is a CD or MP3 audio source, for example, the audio output can continue playing from a pause point, i.e., the point at which the output was stopped to allow for the output from the alternate audio source. However, radio broadcast provides real-time services, and thus it will no longer continue playing from a pause point, thereby the driver will miss some information of the radio broadcast. For example, if the driver misses listening to some important current affairs or real-time road traffic flow information, it will cause great distress to the driver and increase psychological pressure of the driver. Thereby, how to ensure the continuity of the radio broadcast is an urgent problem to be solved.

### SUMMARY OF THE INVENTION

To support batch processing for the data, embodiments of the present invention provide a data storage method and a data storage device, and a common data type of component.

According to one embodiment of this disclosure, a radio broadcast receiving method includes: receiving radio signals comprising an over-the-air radio broadcast; playing the received radio signals as the radio broadcast; storing the received radio signals; based at least in part on receiving a radio broadcast pause event: stopping playing the radio broadcast, recording a pause point of the stored radio signals comprising a point at which the radio broadcast was stopped, and while the radio broadcast is stopped, continuing receiving the radio signals as the radio broadcast and storing the received radio signals as stored radio signals; and based at least in part on receiving a radio broadcast playing event after receiving the radio broadcast pause event, commencing the radio broadcast from the pause point by playing the stored radio signals from the pause point.

According to another embodiment of the present invention, the radio broadcast receiving device includes: a radio broadcast receiving module, adapted to receive radio signals comprising an over-the-air radio broadcast; a storing module in communication with the radio broadcast receiving module and adapted to store the radio signals received by the radio broadcast receiving module as stored radio signals; a sound output module in communication with the storing module and adapted to play the stored radio signals; a controller, adapted to: at least in part in response to receiving a radio broadcast pause event, control the sound output module to stop playing the stored radio signals and record a pause point comprising a point at which the radio broadcast is paused, and at least in part in response to receiving a radio playing signal after receiving the radio broadcast pause event, control the sound output module to play the stored radio signals from the pause point.

According to another embodiment of the present disclosure, a vehicle-mounted system includes: the above-mentioned radio broadcast receiving device and an input device for receiving signals networked to the vehicle-mounted system.

Embodiments of the present disclosure may provide several advantages, including but not limited to the following.

The radio broadcast receiving method, device and the vehicle-mounted system provided by the present disclosure can, if receive a pause request, continue receiving and storing the radio signals, thereby ensuring the continuity of the received radio signals. In addition, if a radio playing signal is received, the stored radio signals are played from the pause point, thereby, avoiding repeatedly playing the radio information and increasing user experience.

### BRIEF DESCRIPTION OF THE DRAWINGS

FIG. 1 is a flowchart of a radio broadcast receiving method in accordance with example embodiments of the present disclosure;

FIG. 2 is a flowchart of a radio broadcast receiving method in accordance with example embodiments of the present disclosure;

FIG. 3 is a schematic block diagram of a radio broadcast receiving device in accordance with example embodiments of the present disclosure;

FIG. 4 is a schematic block diagram of a radio broadcast receiving device in accordance with example embodiments of the present disclosure; and

FIG. 5 is a schematic block diagram of a vehicle-mounted system in accordance with example embodiments of the present disclosure.

### DETAILED DESCRIPTION OF PREFERRED EMBODIMENTS

To make the objective, the technical solutions and advantages of the present invention more clear and understandable, embodiments of the present disclosure will be described in detail accompanying with figures as follows.

Example embodiments of this disclosure will be described in connection with radio broadcasts. As used herein, radio broadcasts are intended to include over-the-air radio broadcasts, transmitted via radio waves or radio signals, which may be frequency modulated (FM) or amplitude modulated (AM) waves or signal, for example. For example, radio broadcasts may be transmitted via radio transmitters, and, although radio broadcasts may be digital broadcasts, they are intended to be distinguished from digital radio streams, which are transmitted via a network, such as the Internet. Radio broadcasts may also be distinguished from other types of audio streams or types in that they are continuously broadcast from the transmitter. That is, if a user turns the channel, turns off the radio broadcast, or otherwise stops listening to a radio broadcast, the broadcast continues, e.g., so others can “tune in” and listen. Although conventional internet radio or other streaming services may be transmitted using radio frequencies in some instances, such audio may be distinguished because it is “on-demand,” e.g., transmitted individually to a single receiver or listener, upon request from the receiver or listener. In some instances, in audio transmissions other than radio broadcasts, the audio stream may be paused or otherwise stopped, but such a disruption will result in a stop in transmission of the audio, different from what happens in a radio broadcast.

### The First Embodiment

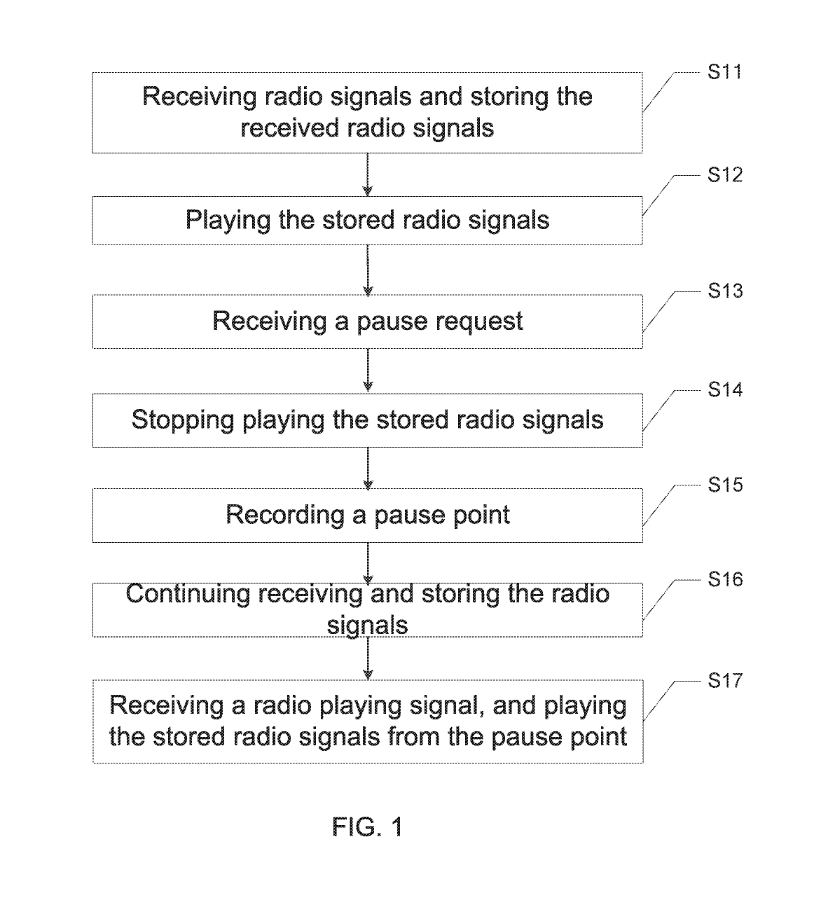

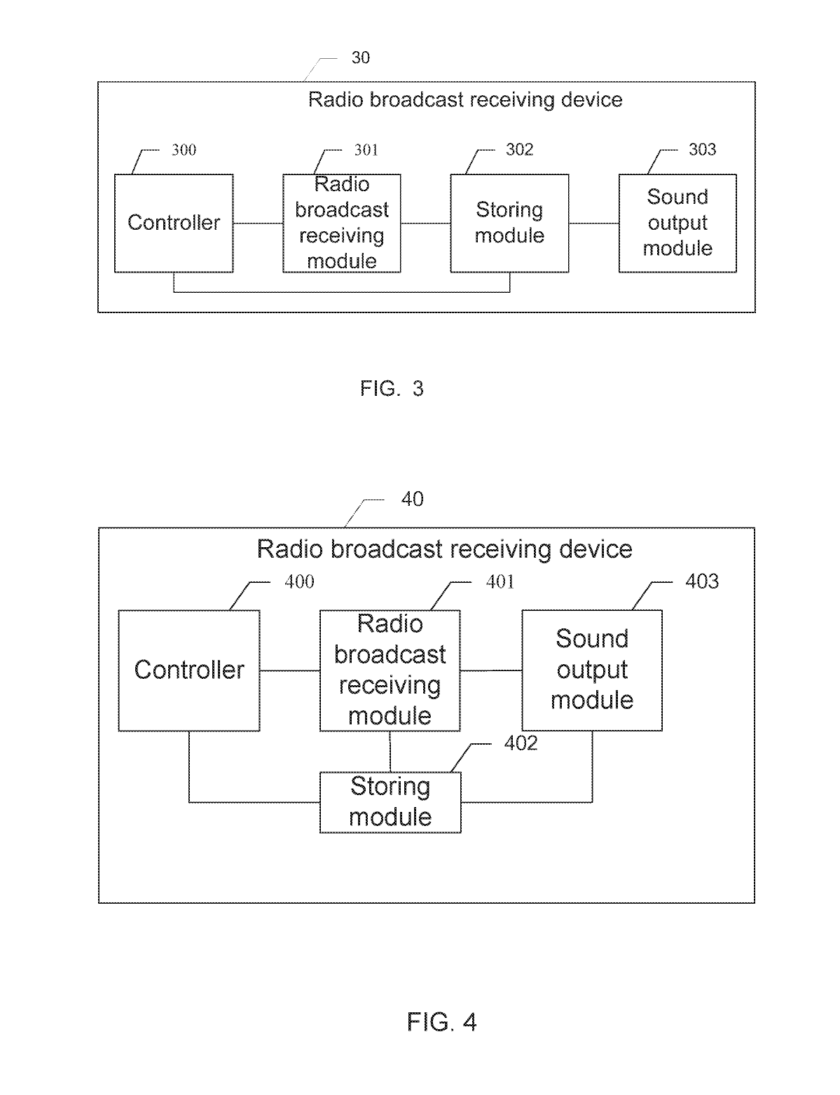

FIG. 1 is a flowchart of a radio broadcast receiving method in accordance with an exemplary embodiment of the present disclosure. For ease of discussion, elements of the radio broadcast receiving method may be discussed as being executed on a radio broadcast receiving device, such as the radio broadcast receiving device as shown in FIG. 3. Referring to FIG. 1, the radio broadcast receiving method may include the following steps:

Step S11: receiving radio signals and storing the received radio signals.

In step S11, transmitted radio broadcast signals, i.e., comprising a radio broadcast, are received, and stored. The radio broadcast may be associated with a particular channel on the radio, for instance.

In some examples, a radio broadcast receiving device, configured to receive the radio signals, may also include or be otherwise associated with non-volatile memory to store the received radio signals. In other embodiments, the radio broadcast receiving device may communicate with a remote storing module being assigned. The remote storing module can also be used to store the received radio signals. The remote storing module may be connected to other modules or devices via a network, which can include, but is not limited to, the Internet, an intranet, a local area network, a mobile communication network, or their combination.

Step S12: playing the stored radio signals.

At step S12, the radio signals received and/or stored at step S11 are played. For example, a radio broadcast receiving device executing the radio broadcast receiving method may include one or more audio outputs connected to, e.g., a speaker, headphones, an automobile audio system, or the like. In alternative embodiments, the radio broadcast receiving device may transmit the received radio signals to an audio output device.

Step S13: Receiving a pause request (e.g., a radio broadcast pause event).

At step S13, a request to pause the playing (or playback) of the radio broadcast is received. For example, a user may instruct a pausing of the playback, e.g., by pressing a pause button, dictating a pause command, or the like.

In other embodiments, receipt of a signal from another device, instead of a user, may be a request to pause the playing of the radio broadcast. For example, other devices and/or applications, including but not limited to a vehicle navigation device or application, a telephone device or application, or other device may have priority over the radio broadcast and thus may access the speaker or other audio output playing the radio broadcast to provide information to the user. The act of accessing the speaker by such device or application for example, a navigation device or application may access the speaker or other audio output to provide the user with navigation instructions, and such access by the device/application may be interpreted as a pause instruction. In another example, a phone may access the audio output, e.g., so the user can carry on a hands-free call, and such access may constitute a pause instruction or pause event. In still further examples, silencing, pausing or placing the radio broadcast receiving device into a synchronous buffer mode, may trigger a pause signal.

Step S14: Stopping playing the stored radio signals.

At step S14, a request to pause the playing (or playback) of the radio broadcast is received, upon receiving the radio pause signal, playing of the stored radio signals are stopped.

Step S15: Recording a pause point.

At step S15, also in response to receiving the pause signal, a pause point is recorded, e.g., a tag.

Step S16: Continuing receiving and storing the radio signals.

In step S16, also in response to receiving the pause signal, the radio signals comprising the radio broadcast continue to be received and stored, in order to ensure the continuity of the received radio signals.

Step S17: Receiving a radio playing signal, and playing the stored radio signals from the pause point.

In some examples, when the vehicle navigation device, the telephone device or other device with high priority has finished broadcasting information through the sound output module, a radio playing signal is received. In addition, if the radio broadcast receiving device is set from silent mode to non-silent mode, or from pause mode to playing mode, or from synchronous buffer mode to synchronous mode, the radio playing signal is received.

In other embodiments of the present disclosure, in order to save storage space, the radio broadcast receiving method may also include receiving a channel changing signal, deleting the stored radio signals of the original channel, and recycling to an initial state.

In other embodiments, storage space may be saved by deleting stored radio signals that have been played. For instance, after the stored radio signals have been played, they may be immediately deleted. In other embodiments, stored radio signals may be deleted based on an elapsed time. For example, stored radio signals may be deleted after an elapsed time from when the radio signals were stored, after an elapsed time from when the radio signals were played, after an elapsed time from when the radio signals were originally broadcasted, or after some other elapsed time.

The radio broadcast receiving method provided by the present embodiment can, if receive a pause request, record a pause point, continue receiving and storing the radio signals, thereby ensuring the continuity of the received radio signals. In addition, if a radio playing signal is received, the stored radio signals are played from the pause point, thereby, avoiding repeatedly playing the radio information and increasing user experience.

### The Second Embodiment

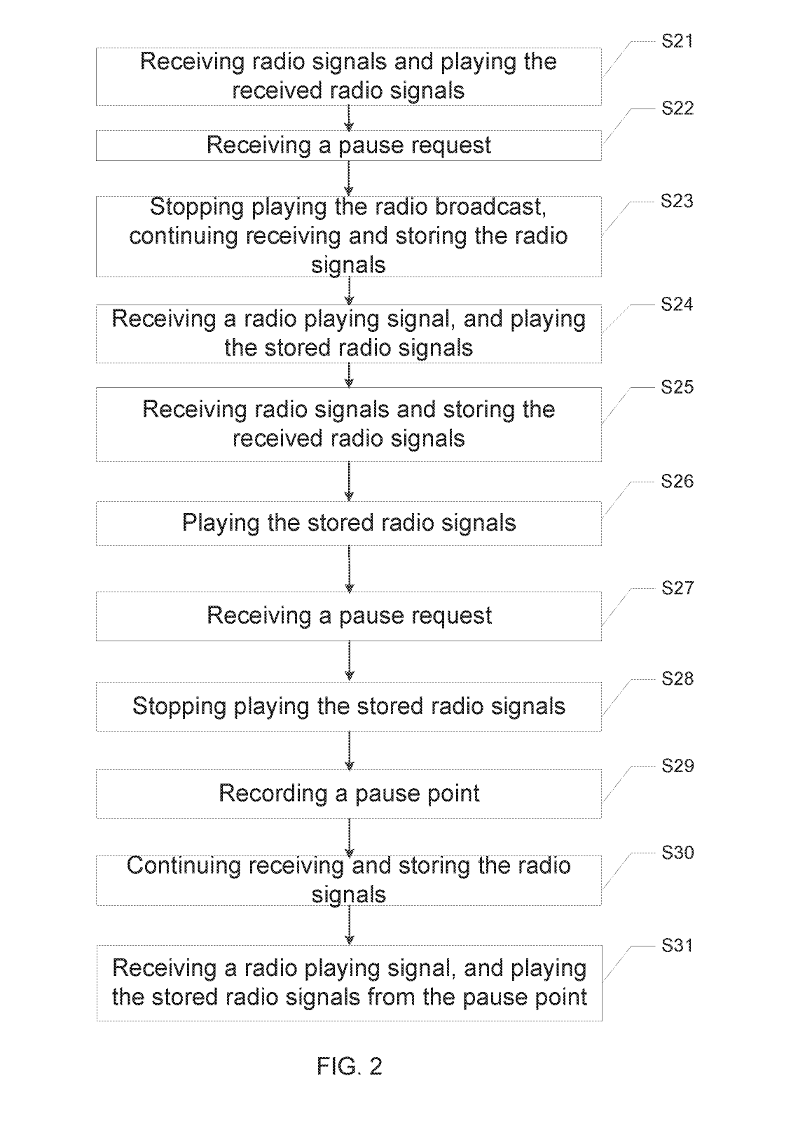

FIG. 2 is a flowchart of a radio broadcast receiving method in accordance with another exemplary embodiment of the disclosure. The radio broadcast receiving method may be discussed as being executed on a radio broadcast receiving device, such as the radio broadcast receiving device as shown in FIG. 4. Referring to FIG. 2, the radio broadcast receiving method may include the following steps:

Step S21: receiving radio signals and playing the received radio signals.

Step S22: Receiving a pause request.

At step S22, a request to pause the playing (or playback) of the radio broadcast is received. For example, a user may instruct a pausing of the playback, e.g., by pressing a pause button, dictating a pause command, or the like.

In other embodiments, receipt of a signal from another device, instead of a user, may be a request to pause the playing of the radio broadcast. For example, other devices and/or applications, including but not limited to a vehicle navigation device or application, a telephone device or application, or other device may have priority over the radio broadcast and thus may access the speaker or other audio output playing the radio broadcast to provide information to the user. The act of accessing the speaker by such device or application for example, a navigation device or application may access the speaker or other audio output to provide the user with navigation instructions, and such access by the device/application may be interpreted as a pause instruction. In another example, a phone may access the audio output, e.g., so the user can carry on a hands-free call, and such access may constitute a pause instruction or pause event. In still further examples, silencing, pausing or placing the radio broadcast receiving device into a synchronous buffer mode, may trigger a pause signal.

Step S23: Stopping playing the radio broadcast, continuing receiving and storing the radio signals.

At step S23, upon receiving the radio pause signal, playing of the radio broadcast is stopped. And also in response to receiving the pause signal, the radio signals comprising the radio broadcast continue to be received and stored, in order to ensure the continuity of the received radio signals.

Step S24: Receiving a radio playing signal, and playing the stored radio signals.

In some examples, when the vehicle navigation device, the telephone device or other device with high priority has finished broadcasting information through the sound output module, a radio playing signal is received. In addition, if the radio broadcast receiving device is set from silent mode to non-silent mode, or from pause mode to playing mode, or from synchronous buffer mode to synchronous mode, the radio playing signal is received.

In other embodiments of the present disclosure, the radio broadcast receiving method may also include the following steps:

Step S25: receiving radio signals and storing the received radio signals.

Step S26: playing the stored radio signals.

Step S27: Receiving a pause request.

Step S28: Stopping playing the stored radio broadcast.

Step S29: Recording a pause point.

Step S30: Continuing receiving and storing the radio signals.

In step S30, also in response to receiving the pause signal, the radio signals comprising the radio broadcast continue to be received and stored, in order to ensure the continuity of the received radio signals.

Step S31: Receiving a radio playing signal, and playing the stored radio signals from the pause point.

In other embodiments of the present disclosure, in order to save storage space, the radio broadcast receiving method may also include receiving a channel changing signal, deleting the stored radio signals of the original channel, and recycling to an initial state.

In other embodiments, storage space may be saved by deleting stored radio signals that have been played.

For instance, after the stored radio signals have been played, they may be immediately deleted. In other embodiments, stored radio signals may be deleted based on an elapsed time. For example, stored radio signals may be deleted after an elapsed time from when the radio signals were stored, after an elapsed time from when the radio signals were played, after an elapsed time from when the radio signals were originally broadcasted, or after some other elapsed time.

The radio broadcast receiving method provided by the present embodiment can play the received radio signals, if receive a pause request, continue receiving and storing the radio signals. In addition, when a radio playing signal is received, the stored radio signals are played, thereby, ensuring the continuity of the received radio signals and reducing the requirements for storage space. Moreover, if receiving a pause request again, recording a pause point, continuing receiving and storing the radio signals in order to ensure the continuity of the received radio signals. In addition, if a radio playing signal is received, the stored radio signals are played from the pause point, thereby, avoiding repeatedly playing the radio information and increasing user experience.

### The Third Embodiment

FIG. 3 is a schematic block diagram of a radio broadcast receiving device in accordance with another exemplary embodiment of the present disclosure. Referring to FIG. 3, the radio broadcast receiving device 30 includes a controller 300, a radio broadcast receiving module 301, a storing module 302, and a sound output module 303.

The radio broadcast receiving module 301 is configured to receive radio signals. The storing module 302 is connected to the radio broadcast receiving module 301, and is configured to store the received radio signals which the radio broadcast receiving module 301 receives.

In some examples, the radio broadcast receiving module 301 may include an antenna to receive radio signals comprising an over-the-air radio broadcast, the storing module 302 can be positioned on a cloud network, and make signal transmission with other modules or devices via network. The storing module 302 may include or be otherwise associated with non-volatile memory to store the received radio signals. In addition, the storing module 302 may communicate with a remote storing module being assigned. The remote storing module can also be used to store the received radio signals.

The sound output module 303 is connected to the storing module 302, and is configured to play the stored radio signals which the storing module 302 stores. And the sound output module 303 may include a speaker that can play the stored radio signals.

The controller 300 is configured to receive a pause request, control the sound output module 303 to stop playing the stored radio signals stored by the storing module 302, and record a pause point. The controller 300 is also configured to receive a radio playing signal, and control the sound output module 303 to play the stored radio signals from the pause point.

In one embodiment of the present invention, the controller 300 is also configured to receive a channel changing signal, e.g., from a user. For example, broadcast a new radio program on a different channel, and, in response to the channel changing signal, delete stored radio signals of the original channel which the storing module 302 stores.

In other embodiments, the controller 300 is also configured to delete stored radio signals that the storing module 302 stores and have been played.

The radio broadcast receiving device provided by the present embodiment can, if receive a pause request, record a pause point, continue receiving and storing the radio signals, thereby ensuring the continuity of the received radio signals. In addition, if a radio playing signal is received, the stored radio signals are played from the pause point, thereby, avoiding repeatedly playing the radio information and increasing user experience.

### The Fourth Embodiment

FIG. 4 is a schematic block diagram of a radio broadcast receiving device in accordance with another exemplary embodiment of the present disclosure. Referring to FIG. 4, the radio broadcast receiving device includes a controller 400, a radio broadcast receiving module 401, a storing module 402, and a sound output module 403.

The radio broadcast receiving module 401 is configured to receive radio signals. The storing module 402 is connected to the radio broadcast receiving module 401, and is configured to store the received radio signals which the radio broadcast receiving module 401 receives.

In some examples, the storing module 402 can be positioned on a cloud network, and make signal transmission with other modules or devices via network.

The sound output module 403 is connected to the radio broadcast receiving module 401, and is configured to play the radio signals which the radio broadcast receiving module 401 receives.

In detail, the sound output module 403 may include a signal decoding unit and a loudspeaker.

The controller 400 is configured to play control the sound output module 403 to play the radio signals which the radio broadcast receiving module 401 receives, receive a pause request, control the sound output module 403 to stop playing the radio signals which the radio broadcast receiving module 401 receives, control the storing module 402 to store the radio signals which the radio broadcast receiving module 401 receives. The controller 400 is also configured to receive a radio playing signal, and control the sound output module 403 to play the stored radio signals which the storing module 402 stores.

In addition, in one embodiment of the present invention, the controller 400 is also connected to the storing module 402, and is configured to play the stored radio signals which the storing module 402 stores. The controller 400 is also configured to receive a pause request again, control the sound output module 403 to stop playing the stored radio signals stored by the storing module 402, and record a pause point. The controller 400 is also configured to receive a radio playing signal again, and control the sound output module 403 to play the stored radio signals from the pause point.

In one embodiment of the present invention, the controller 400 is also configured to receive a channel changing signal, e.g., from a user. For example, broadcast a new radio program on a different channel, and, in response to the channel changing signal, delete the stored radio signals of the original channel which the storing module 402 stores.

In other embodiments, the controller 400 is also configured to delete the stored radio signals that the storing module 402 stores and have been played.

The radio broadcast receiving device provided by the present embodiment can play the received radio signals, if receive a pause request, continue receiving and storing the radio signals. In addition, when a radio playing signal is received, the stored radio signals are played, thereby, ensuring the continuity of the received radio signals and reducing the requirements for storage space. Moreover, if receiving a pause request again, recording a pause point, continuing receiving and storing the radio signals in order to ensure the continuity of the received radio signals. In addition, if a radio playing signal is received, the stored radio signals are played from the pause point, thereby, avoiding repeatedly playing the radio information and increasing user experience.

### The Fifth Embodiment

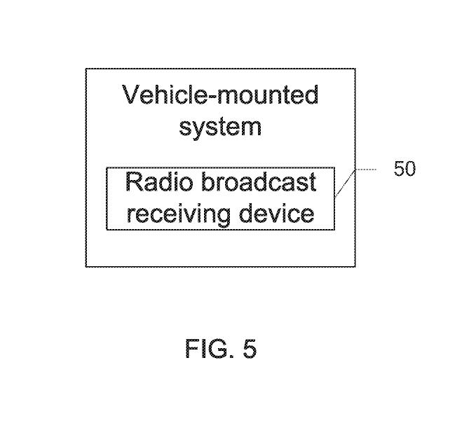

FIG. 5 is a schematic block diagram of a vehicle-mounted system in accordance with another exemplary embodiment of the present disclosure. Referring to FIG. 5, the vehicle-mounted system includes a radio broadcast receiving device 50, a vehicle navigation device, a telephone device, and an input device for receiving signals networked to the vehicle-mounted system. The specific structure of the radio broadcast receiving device 50 can refer to the radio broadcast receiving device as shown in FIG. 3 and FIG. 4.

The radio broadcast receiving method, device and the vehicle-mounted system provided by the present embodiment can, if receive a pause request, continue receiving and storing the radio signals, thereby ensuring the continuity of the received radio signals. In addition, if a radio playing signal is received, the stored radio signals are played from the pause point, thereby, avoiding repeatedly playing the radio information and increasing user experience.

The above descriptions are only preferred embodiments of the present invention, and are not intended to limit the present invention. Any amendments, replacement and modification made to the above embodiments under the principle of the present invention should be included in the scope of the present invention.

1. A radio broadcast receiving method comprising:
receiving radio signals comprising an over-the-air radio broadcast;
playing the received radio signals as the radio broadcast;
storing the received radio signals;
based at least in part on receiving a radio broadcast pause event:
stopping playing the radio broadcast;
recording a pause point of the stored radio signals comprising a point at which the radio broadcast was stopped; and
while the radio broadcast is stopped, continuing receiving the radio signals as the radio broadcast and storing the received radio signals as stored radio signals; and
based at least in part on receiving a radio broadcast playing event after receiving the radio broadcast pause event, commencing the radio broadcast from the pause point by playing the stored radio signals from the pause point.

2. The method as claimed in claim 1, wherein the stored radio signals are stored at least in part in response to receiving the radio broadcast playing event.

3. The method as claimed in claim 1, wherein the receiving the radio broadcast pause event comprises at least one of: receiving a signal from a vehicle navigation device, or receiving a signal from a telephone device.

4. The method as claimed in claim 1, wherein the receiving the radio broadcast pause event comprises receiving a signal to mute the radio broadcast.

5. The method as claimed in claim 1, further comprising:
receiving channel change instruction comprising an instruction to change a channel associated with the radio broadcast; and
at least in part in response to receiving the channel change instruction, deleting the stored radio signals.

6. The method as claimed in claim 1, further comprising deleting the stored radio signals which have been played.

7. A radio broadcast receiving device, comprising: a radio broadcast receiving module, adapted to receive radio signals comprising an over-the-air radio broadcast;
a storing module in communication with the radio broadcast receiving module and adapted to store the radio signals received by the radio broadcast receiving module as stored radio signals;
a sound output module in communication with the storing module and adapted to play the stored radio signals;
a controller, adapted to:
at least in part in response to receiving a radio broadcast pause event, control the sound output module to stop playing the stored radio signals and record a pause point comprising a point at which the radio broadcast is paused; and
at least in part in response to receiving a radio playing signal after receiving the radio broadcast pause event, control the sound output module to play the stored radio signals from the pause point.

8. The device as claimed in claim 7, wherein the sound output module is also in communication with the radio broadcast receiving module and is adapted to play the radio signals received by the radio broadcast receiving module, and
wherein the controller is also adapted to control the storing module to store the radio signals received by the receiving device at least in part in response to receiving the radio broadcast pause event and to control the storing module to abstain from storing the radio signals received by the receiving device in the absence of a radio broadcast pause event.

9. The device as claimed in claim 7, wherein the radio broadcast pause event comprises at least one of a signal from a vehicle navigation device or a signal from a telephone device accessing the sound output module.

10. The device as claimed in claim 7, wherein the radio broadcast pause event comprises a signal placing the radio broadcast receiving device into a silent mode.

11. The device as claimed in claim 7, wherein the controller is further adapted to, delete the stored radio signals at least in part in response to a change channel instruction.

12. The device as claimed in claim 7, wherein the controller is further adapted to delete the stored radio signals after the stored radio signals have been played by the sound output module.

13. The device as claimed in claim 7, wherein the storing module comprises a cloud network.

14. A vehicle-mounted system, the system comprising: the radio broadcast receiving device as claimed in claim 7 and an input device for receiving signals networked to the vehicle-mounted system.

15. A vehicle-mounted system, the system comprising: the radio broadcast receiving device as claimed in claim 8 and an input device for receiving signals networked to the vehicle-mounted system.
